(19) United States
(12) Patent Application Publication
(10) Pub. No.: US 2023/0394338 A1
(43) Pub. Date: Dec. 7, 2023

(54) METHOD AND SYSTEM FOR FACILITATING FORECASTING

(71) Applicant: Armand Prieditis, McKinleyville, CA (US)

(72) Inventor: Armand Prieditis, McKinleyville, CA (US)

(21) Appl. No.: 17/832,293

(22) Filed: Jun. 3, 2022

(51) Int. Cl. G06N 7/00; G06K 9/62

(52) U.S. Cl. CPC G06N 7/005; G06K 9/6298

(57) ABSTRACT

One embodiment of the subject matter can facilitate forecasting by non-linearly combining prior information and leveraging prior information at any time point based on dynamic programming and a probabilistic model that considers both neighbor states and values. This embodiment has several advantages. First, the probabilistic model can be learned from training data. Second, its non-linearity facilitates improved forecasting accuracy. Third, it is efficient for prediction and can be parallelized over the training data to yield a learning time that is linear in the maximum number of elements in the sequences in the training data. Fourth, it is optimal in that it guarantees a forecast that is a most likely one based on the principle of optimality in dynamic programming and basic probability.

### BACKGROUND

### Field

The subject matter relates to forecasting. Forecasting involves making a prediction about a future observation based on a model and prior observations.

### Related Art

Forecasting is important where estimates of future conditions are useful. For example, forecasting is useful in predicting the weather, customer demand, economic trends, network traffic, stock prices, currency value, and commodity value. Forecasting has also been used to predict conflict in the world.

Forecasting methods include Auto-Regression (AR), which linearly combines prior observations, Moving Average (MA), which linearly combines prior residual errors, Autoregressive Moving Average (ARMA), which linearly combines both prior observations and prior residual errors, Autoregressive Integrated Moving Average (ARIMA), which linearly combines differenced prior observations and prior residual errors, Seasonal Autoregressive Integrated Moving Average (SARIMA), which linearly combines differenced prior observations, prior residual errors, differenced prior seasonal observations, and prior seasonal errors, and Seasonal Autoregressive Integrated Moving-Average with Exogenous Regressors (SARIMAX), which is an extension of the SARIMA model that includes exogenous observations. Exogenous observations are parallel time series that are not modeled in the same way as the primary (endogenous) observations but can influence the forecasted variable.

Other methods include Vector Autoregression (VAR), which is a multivariate version of AR, Vector Autoregression Moving-Average (VARMA), which is a multivariate version of ARMA, Vector Autoregression Moving-Average with Exogenous Regressors (VARMAX), which is a multivariate exogenous observation extension of VARMA, Simple Exponential Smoothing (SES), which linearly combines exponentially weighted prior observations, and Holt Winter's Exponential Smoothing (HWES), which linearly combines exponentially weighted prior observations and takes trends and seasonality into account. Typically, a forecast can also include the degree of uncertainty attached to the forecast.

These methods have two major shortcomings. First, they are limited to linear combinations of prior information such as observations, residuals, trends, and seasonality. They can't be used for forecasts that require a non-linear combination of prior information.

Second, these methods require a priori fixing the number of time steps associated prior information. These methods ignore any information beyond these fixed number of time steps. In short, there's no way for these methods to pass information from prior time steps beyond these fixed number of time steps. Worse still, those methods require the same fixed number of time steps for both learning (setting the parameters based on training data) and prediction.

Hence, what is needed is a method and a system for forecasting that can non-linearly combine prior information and leverage prior information at any time point.

### SUMMARY

One embodiment of the subject matter can facilitate forecasting by non-linearly combining prior information and leveraging prior information at any time point based on dynamic programming and a probabilistic model that considers both neighbor states and values. This embodiment has several advantages. First, the probabilistic model can be learned from training data. Second, its non-linearity facilitates improved forecasting accuracy. Third, it is efficient for prediction and can be parallelized over the training data to yield a learning time that is linear in the maximum number of elements in the sequences in the training data. Fourth, it is optimal in that it guarantees a forecast that is a most likely one based on the principle of optimality in dynamic programming and basic probability. Fifth, it can propagate information from one part of the time-series data to another for improved accuracy. Sixth, it can predict both the most likely value and the uncertainty (covariance) of the prediction.

The details of one or more embodiments of the subject matter are set forth in the accompanying drawings and the description below. Other features, aspects, and advantages of the subject matter will become apparent from the description, the drawings, and the claims.

### BRIEF DESCRIPTION OF THE FIGURES

FIG. 1 presents an example system for facilitating forecasting.

In the FIGURES, like reference numerals refer to the same FIGURE elements.

### DETAILED DESCRIPTION

In embodiments of the subject matter, each observation (element) of a time series comprises one or more continuous values. A discrete-valued element can be represented as a one-hot vector of continuous values.

In embodiments of the subject matter, the forecasting task is to predict observations up to time point n, given a model and prior observations up to time point j where 1≤j<n. More formally, observations correspond to column vectors of one or more continuous values. The model corresponds to mixtures of multivariate Gaussians where the state corresponds to a mixture identifier (i.e., a label, an index). During operation, embodiments of the subject matter can execute the following procedure.

```
#determine most likely states
#for each observation in the time series
s ∈ S:
  ${t}_{1 , s} ← ℒ ( [ \begin{matrix}{x}_{1} \\ h ( s )\end{matrix} ] ) , μ , Σ )$
  g_{1,s,} ← s
  o_{1,s,} ← x₁
u₁ ← y₁
2 ≤ i ≤ j:
  s ∈ S:
    ${t}_{i , s} ← {max}_{{s}^{′} ∈ S} \{ l ( [ \begin{matrix}{x}_{i} \\ h ( s )\end{matrix} ] \vert [ \begin{matrix}{x}_{i - 1} \\ h ( {s}^{′} )\end{matrix} ] , γ : τ , {γ}^{′} : {τ}^{′} , \dot{μ} , \dot{Σ} ) + {t}_{i - 1 , {s}^{′}} \}$
    ${g}_{i , s} ← {argmax}_{{s}^{′} ∈ S} \{ l ( [ \begin{matrix}{x}_{i} \\ h ( s )\end{matrix} ] \vert [ \begin{matrix}{x}_{i - 1} \\ h ( {s}^{′} )\end{matrix} ] , γ : τ , {γ}^{′} : {τ}^{′} , \dot{μ} , \dot{Σ} ) + {t}_{i - 1 , {s}^{′}} \}$
    o_{i,s} ← xᵢ
uᵢ ← yᵢ
j + 1 ≤ i ≤ n:
    s ∈ S:
      ${t}_{i , s} ← {max}_{{s}^{′} ∈ S} \{ l ( h ( s ) \vert [ \begin{matrix}{o}_{i - 1 , {s}^{′}} \\ h ( {s}^{′} )\end{matrix} ] , τ : τ , {γ}^{′} : {τ}^{′} , \dot{μ} , \dot{Σ} ) + {t}_{i - 1 , {s}^{′}} \}$
      ${g}_{i , s} ← {argmax}_{{s}^{′} ∈ S} \{ l ( h ( s ) \vert [ \begin{matrix}{o}_{i - 1 , {s}^{′}} \\ h ( {s}^{′} )\end{matrix} ] , τ : τ , {γ}^{′} : {τ}^{′} , \dot{μ} , \dot{Σ} ) + {t}_{i - 1 , {s}^{′}} \}$
      ${o}_{i , s} ← \hat{μ} ( [ \begin{matrix}h ( s ) \\ {o}_{i - 1 , {g}_{i , s}} \\ h ( {g}_{i , s} )\end{matrix} ] , γ : γ , τ : {τ}^{′} , \dot{μ} , \dot{Σ} )$
    uᵢ ← (\dot{Σ}_{γ:γ,γ′:γ′}\dot{Σ}_{γ′:γ′,γ′:γ′})uᵢ₋₁(\dot{Σ}_{γ:γ,γ′:γ′}\dot{Σ}_{γ′:γ′,γ′:γ′)}^{T}
#backtrace
${r}_{n} ← {argmax}_{s ∈ S} \{ {t}_{n , s} \}$
  n ≥ i ≥ 2:rᵢ₋₁ ← g_{i,r}_{ᵢ}
#output prior observations + forecasted observations
1 ≤ i ≤ n:vᵢ ← o_{i,r}_{ᵢ}
```

First, embodiments of the subject matter determine the most likely states for each observation in the sequence of observations (also known as a time series). Here, S corresponds to a non-empty set of states. Typically, the set of states S={1 . . . k}, where k is a positive integer. States are like mixture components in a mixture model: they are merely identifiers that operate like a subclass in a model. More generally, the set of states S can be any finite set of k elements such as {a,b,c,d}. Though the states have different labels, the number of states is the same and hence these two different state sets can be treated equivalently by embodiments of the subject matter. For convenience of implementation, a preferred embodiment of the subject matter comprises states S={1 . . . k}, which is equivalent to any k element set of labels in embodiments of the subject matter.

The expression s∈S: corresponds to a “for” loop that is executed for every state s∈S. For each element in the sequence, for each state, t_{i,s} stores the sum of the log maximum likelihood based on observations at positions less than i and at predecessor states s. Previously computed values of t_{i,s} can be used to determine t for larger values of i and other states by using dynamic programming, which will be described shortly.

The function

$$ℒ ( [ \begin{matrix}{x}_{1} \\ h ( s )\end{matrix} ] , μ , Σ )$$

returns the log likelihood of

$$[ \begin{matrix}{x}_{1} \\ h ( s )\end{matrix} ]$$

given mean vector μ and covariance matrix Σ, where [symbol] (x, μ, Σ)=(x−μ)^{T}Σ⁻¹(x−μ). More generally, the function [symbol] returns the ln (natural log) of the probability of x in a multivariate Gaussian distribution with mean μ and covariance matrix Σ. Here, constants such as π, ½ and ln |Σ| are removed because they don't affect the maximization outcome in embodiments of the subject matter. Note that [symbol] is the same as the Mahalanobis distance squared. Also, M^{T} is the transpose of matrix M, and Σ⁻¹ is the inverse of a square matrix Σ. The column vector

$$[ \begin{matrix}{x}_{1} \\ h ( s )\end{matrix} ]$$

corresponds to a concatenation of the first observation x₁ in time series x and a one-hotted version h(s) of the state s. For example, if there are three states, the one-hot vector for the first state can be represented as length 3 column vector with a one in the first position and zeroes elsewhere:

$$[ \begin{matrix}1 \\ 0 \\ 0\end{matrix} ] .$$

A one-hot representation is frequently used in machine learning to handle categorical data. In this representation a k-category variable is converted to a k-length vector, where a l in location i of the k-length vector corresponds to the i^{th} categorical variable; the rest of the vector values are 0. For example, if the categories are A, B, and C, then a one-hot representation corresponds to a length three vector where A can be represented as

$$[ \begin{matrix}1 \\ 0 \\ 0\end{matrix} ] ,$$

### B as

$$[ \begin{matrix}0 \\ 1 \\ 0\end{matrix} ] ,$$

### and C as

$$[ \begin{matrix}0 \\ 0 \\ 1\end{matrix} ] .$$

Other permutations of the vector can be used to equivalently represent the same three categorical variables. Other variants of one-hot encoding, such as dummy encoding can also be used.

The mean vector μ is conformably partitioned as

$$[ \begin{matrix}{μ}_{γ} \\ {μ}_{τ}\end{matrix} ] ,$$

where μ_{γ} corresponds to the mean of the first element, μ_{τ} corresponds to the mean of the one-hot representation of the state for the first element. The covariance matrix λ is similarly conformably partitioned as

$$[ \begin{matrix}{Σ}_{γ , γ} & {Σ}_{γ , τ} \\ {Σ}_{τ , γ} & {Σ}_{τ , τ}\end{matrix} ] .$$

The assignment g_{1,s},←s sets the first value of the most likely state to s and the assignment o_{1,s}←x₁ sets the first observation for the state to be x₁, which is the actual first observation. The assignment u₁←y₁ sets the first value for the uncertainty of the prediction to be y₁, where y₁ is a covariance matrix corresponding to the uncertainty associated with the first observation. For example, xᵢ can correspond to measurement from a scientific device with a known error (uncertainty) among the values in x₁. This uncertainty can be represented by a covariance matrix in embodiments of the subject matter. For example, the uncertainty can correspond to the identity matrix I for such measurements. More generally, the uncertainty can relate all values in an observation to all other values. The value corresponding to uncertainty will be propagated with inferences. Note that in embodiments of the subject matter, u is not indexed by the state because the uncertainty propagates independent of the state. More on propagation will be described shortly.

Now that the initial values of t, g, o, and u are set, the subsequent values below j can be set in the loop 2≤i≤j and within that loop, for each state s∈S. The assignment

$${t}_{i , s} ← {max}_{{s}^{′} ∈ S} \{ l ( [ \begin{matrix}{x}_{i} \\ h ( s )\end{matrix} ] \vert [ \begin{matrix}{x}_{i ‐ 1} \\ h ( {s}^{′} )\end{matrix} ] , γ : τ , {γ}^{′} : {τ}^{′} , \dot{μ} , \dot{Σ} ) + {t}_{i - 1 , {s}^{′}} \}$$

sets t_{i,s} to the maximum likelihood of the sequence at position i for state s, where l(x|y, a, b, μ, Σ)= [symbol] (x, μₐ+Σ_{a,b}Σ_{b,b}⁻¹(y−μ_{b}), Σₐ−Σ_{a,b}Σ_{b,b}⁻¹Σ_{b,a}). The function l returns the log of the probability of a conditional multivariate Gaussian distribution.

The undotted vectors and matrices correspond to the edge cases for training: they are based on data at the first position in the sequence. The dotted vectors and matrices correspond to the non-edge cases: they are based on data at all subsequence positions in the sequence.

The second mean vector \dot{μ} is conformably partitioned as

$$[ \begin{matrix}{\dot{μ}}_{γ} \\ {\dot{μ}}_{τ} \\ {\dot{μ}}_{{γ}^{′}} \\ {\dot{μ}}_{{τ}^{′}}\end{matrix} ] ,$$

where \hat{μ}_{γ} corresponds to the mean of the i^{th} element (where i>1), \dot{μ}_{τ} corresponds to the mean of the one-hot representation of the state for the i^{th} element, \dot{μ}_{γ}′ corresponds to the mean of the i−1^{st} element (The prime (′) notation refers to an immediate predecessor in the sequence), and \dot{μ}_{τ′} corresponds to the mean of the one-hot representation of the state for the i−1^{st} element.

Also similarly, the second covariance matrix \dot{Σ} is conformably partitioned as

$$[ \begin{matrix}{\dot{\sum }}_{γ , γ} & … & {\dot{\sum }}_{γ , {τ}^{′}} \\ ⋮ & ⋱ & ⋮ \\ {\dot{\sum }}_{{τ}^{′} , γ} & … & {\dot{\sum }}_{{τ}^{′} , {τ}^{′}}\end{matrix} ] .$$

The range notation a: b follows the order of variables that appear in μ, Σ, \dot{μ} and \dot{Σ}. For example, γ′: τ′ specifies a range of blocks from γ′ to τ′, inclusive: γ′, τ′. This range notation is merely a compact and succinct way to specify successive blocks of a conformably partitioned vector or matrix.

The assignment

$${g}_{i , s} ← {arg max}_{{s}^{′} ∈ S} \{ l ( [ \begin{matrix}{x}_{i} \\ h ( s )\end{matrix} ] \vert [ \begin{matrix}{x}_{i ‐ 1} \\ h ( {s}^{′} )\end{matrix} ] , γ : τ , {γ}^{′} : {τ}^{′} , \dot{μ} , \dot{Σ} ) + {t}_{i - 1 , {s}^{′}} \}$$

sets g_{i,s} to the state associated with the maximum likelihood, namely that s′ that results in the maximum likelihood. The assignment o_{i,s}←xᵢ sets the observation for state s and position i to be the actual observation. Recall that at positions j and below, actual observations are used. The assignment uᵢ←yᵢ sets the uncertainty at position i to be the actual (given) uncertainty at position i.

Embodiments of the subject matter can leverage both dynamic programming and multivariate Gaussian distributions. These embodiments can leverage dynamic programming by using the state and sequence location as an index to save precomputed results. These embodiments can also leverage multivariate Gaussian distributions by using a one-hot version of the state. For example, t_{1,s} can be precomputed and stored for reuse through dynamic programming because t can be indexed by the position and state. Also, h(s), can be used in a Gaussian distribution because each one-hot version comprises a vector of continuous values (though it is represented as a vector of continuous values, one of which is always a 1 and the rest zeros).

The base values of t, g, o and u can be used to set values of these arrays later in the sequence through dynamic programming. An alternative to the base values and μ and Σ is to include a dummy border (a dummy first position that occurs prior to the actual first position in the sequence) and only use \dot{μ} and \dot{Σ}, and the subsequent “for” loop, which will be described shortly.

Although such dummy borders are common in image processing to reduce code, the problem with dummy borders is that a dummy state is required for those edges as well as dummy values at the location associated with the dummy. Zeros are often used as for such values associated with dummy borders, but this can bias the values of \dot{μ} and \dot{Σ}, especially if zeros are actual values in the rest of the sequence.

A disadvantage of using edge cases (i.e., not using dummies) is that for learning, statistically, there are less edge cases in training data. For example, with n k-length sequences, there will only be n edge cases but n×k interior cases. However, in the spirit of greater clarity and potentially improved accuracy, description of embodiments of the subject matter here avoid minor tricks such as a dummy border to reduce the amount of code.

The next loop, j+1≤i≤n, handles observation predictions based on both the state and prior observations and states. The first assignment

$${t}_{i , s} ← {max}_{{s}^{′} ∈ S} \{ l ( h ( s ) \vert [ \begin{matrix}{o}_{i ‐ 1 , {s}^{′}} \\ h ( {s}^{′} )\end{matrix} ] , τ : τ , {γ}^{′} : {τ}^{′} , \dot{μ} , \dot{Σ} ) + {t}_{i - 1 , {s}^{′}} \}$$

sets the likelihood for i, s. As in the situation for i≤j, this assignment is based on dynamic programming. However, in this case, the observation is not known but the prior observation, which may be a prediction, is known. Hence, the conditional is based on the known value h(s), which is the one-hotted state, the prior observation o_{i-1,s′}, and the prior one-hotted state h(s′). A benefit of the multivariate Gaussian distribution is that variables that are not known (i.e. the observation at position 1), can simply be ignored.

The most likely state g_{i,s} is similarly assigned. The assignment

$${o}_{i , s} ← \hat{μ} ( [ \begin{matrix}h ( s ) \\ {o}_{i - 1 , {g}_{i , s}} \\ h ( {g}_{i , s} )\end{matrix} ] , γ : γ , τ : {τ}^{′} , \dot{μ} , \dot{Σ} )$$

sets the most likely observation for state s and position i. Unlike the other assignments for o_{i,s}, which merely copy the actual observation at position i, this assignment involves a prediction where \hat{μ}(x, a, b, μ, Σ)=μₐ+Σ_{a,b}Σ_{b,b}⁻¹ (x−μ_{b}), which is the conditional mean of a multivariate Gaussian distribution. In the function \hat{μ}, the variable a corresponds to a block for the predicted variable and the variable b corresponds to the block for the input variables. In this case, the input variables correspond to the one-hotted version of the state s, the previous prior observation (which can itself be a prediction), and the one-hotted version of the state prior to s Note that both the prior observation and the state prior to shave been determined by dynamic programming.

The term dynamic programming as used by embodiments of the subject matter is that quantities precomputed earlier in the sequence can be used to later in the sequence. Dynamic programming is efficient because of this re-use of precomputed data. More generally, dynamic programming can be used to solve an optimization problem by dividing it into simpler subproblems where an optimal solution to the overall problem is based on an optimal solution to the simpler subproblems. In embodiments of the subject matter, the optimization problem is maximization and “simpler” corresponds values that have been precomputed earlier in the sequence.

The assignment

$${u}_{i} ← ( {\dot{\sum }}_{γ : γ , {γ}^{′} : {γ}^{′}} {\dot{\sum }}_{{γ}^{′} : {γ}^{′} , {γ}^{′} : {γ}^{′}} ) {{u}_{i - 1} ( {\dot{\sum }}_{γ : γ , {γ}^{′} : {γ}^{′}} {\dot{\sum }}_{{γ}^{′} : {γ}^{′} , {γ}^{′} : {γ}^{′}} )}^{T}$$

propagates uncertainty from the prior uncertainty (i.e., the one associated with position i−1) to the uncertainty associated with position i. This expression uses the appropriate blocks in the covariance matrix to propagate this uncertainty and is based on a probability theorem related to a linear combination of inputs to a multivariate Gaussian.

Embodiments of the subject matter next backtrace the assignments to find that sequence of states that maximizes the likelihood of the sequence, both actual and predicted. The backtrace begins with determining the most likely final state with the assignment

$${r}_{n} ← {arg max}_{s ∈ S} \{ {t}_{n , s} \} .$$

Subsequently, the loop n≥i≥2, which runs backwards from n down to 2, sets the states for all the remaining positions based on rᵢ₋₁←g_{i,r}_{ᵢ}. This assignment also uses dynamic programming, but from later positions rather than earlier ones.

Finally, all of the prior observations plus forecasted observations can be determined with 1≤i≤n: vᵢ←o_{i,r}_{ᵢ}. These observations are associated with the most likely states at each position.

Embodiments of the subject matter can execute the following steps to learn a prediction model, which comprises the parameters μ, Σ, \dot{μ}, \dot{Σ}.

In embodiments of the subject matter, the first step in learning the parameters μ, Σ, \dot{μ}, and \dot{Σ} in the prediction model is to randomly initialize the states for each element in each sequence (training example). This is shown in the box below. Here, mⱼ corresponds to the number of elements in the sequence for training example j, and r_{j,i} corresponds to the state associated with element i in training example j. The function random(S) randomly selects a state from the set of states S.

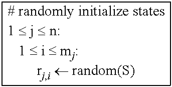

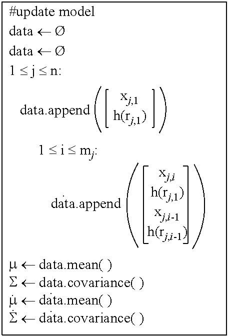

Next, embodiments of the subject matter can execute the update model box above. The box describes two data stores, data and data both of which are initially set to empty (i.e., ø). These data stores can correspond to sets, lists, arrays of data, or any other structure capable of storing and retrieving data. Within the outer loop 1≤j≤n, embodiments of the subject matter first handle the edge cases for each training sequence, where x_{j,i} is the ith element of the j^{th} training example and h(r_{j,1}) is the one-hotted version of the currently assigned state for the 1^{st} position of the j^{th} training example. In embodiments of the subject matter, the inner loop handles the internal cases for each training sequence (mⱼ is the sequence length of the j^{th} training example).

Similarly, embodiments of the subject matter append

$$[ \begin{matrix}{x}_{j , i} \\ h ( {r}_{j , i} ) \\ {x}_{j , i ‐ 1} \\ h ( {r}_{j , i ‐ 1} )\end{matrix} ]$$

to the other data store. This append is for the interior cases. In either case (edge and interior), the append operation adds to the corresponding example to the training data. Subsequently, when all data has been appended, embodiments of the subject matter can determine the mean and covariance matrices of each set of training data. Multiple ways can be used to determine these matrices. Moreover, to prevent singularity in the covariance matrices, a small value can be added along the diagonal of each covariance matrix.

Embodiments of the subject matter can predict the most likely states for every element of every training example and then update the mean and covariance matrix. These steps are shown in the box below. After embodiments of the subject matter execute the update model box, the next few steps are similar to the prediction method in embodiments of the subject matter, except that the class is known during training. After each training example is processed, embodiments of the subject matter can execute the backtrace box, which determines a most likely sequence of states, which can be subsequently used to update the model (the top of the repeat until convergence box) after all training examples are processed. The backtrace box determines states for the next round of processing in the repeat until convergence box.

The backtrace assignments begin with the last index value, m, in the sequence. Specifically, the assignment

$${r}_{j , {m}_{j}} ← {arg max}_{s ∈ S} \{ {t}_{{m}_{j} , s} \}$$

stores the most likely state for position m in the j^{th} sequence.

Subsequently, mⱼ≥i≥2: r_{j,i-1}←g_{i,r}_{_{j,i}} sets the values for the remaining positions from mⱼ down to 2. Because the “for” loop runs from mⱼ down to 2, the assignment is based on the previously set index value r_{j,i}. This is another use of dynamic programming in embodiments of the subject matter.

The steps of model updates, prediction, and backtrace can repeat until convergence. Convergence can be defined in several ways. One way is with a fixed number of iterations of the above routine. Another way is until a difference of an aggregation of

$${max}_{s ∈ S} \{ {t}_{j , {m}_{j}} \}$$

over all training examples 1≤j≤n between successive iterations is less than a given threshold. Aggregation functions include but are not limited to sum, mean, min, max. A difference can be absolute or relative. Convergence can also be defined as reaching a local maximum in likelihood.

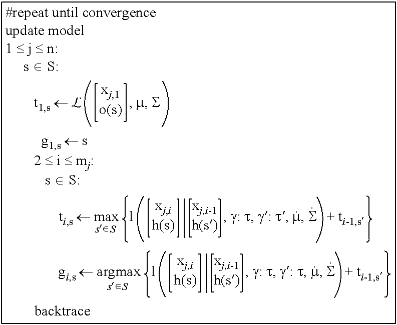

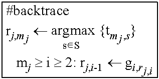

The probability of finding a global maximum likelihood associated with the model can increase with multiple random restarts, which can be run in parallel to result in different model. The model with the largest sum of

$${max}_{s ∈ S} \{ {t}_{{m}_{j} , s} \}$$

over all training examples j can be chosen as the best model. Alternatively, an ensemble of the top k models can be chosen for prediction. Multiple different ensembling methods can be used to combine them during prediction including choosing the most frequently predicted class across all the ensembles or the most frequent class across weighted ensembles, where the weighting itself can be learned.

Note that a mathematically equivalent version of the assignment for t and g can be defined in terms of a product of probabilities rather than a sum of log of the probabilities. The product of probabilities can result in extremely low numbers, which can cause hardware underflow. A preferred embodiment of the subject matter uses the sum of the natural logarithm of the probabilities. Moreover, with this form, the multivariate Gaussian distribution simplifies so that no exponentials are required. Other mathematically equivalent expressions can be used as well as approximations of the multivariate Gaussian distribution.

An appropriate number of states (as in {1 . . . k}) can be determined in multiple different ways. For example, a validation set of sequences can be reserved and used to evaluate the likelihood of the sequences using an aggregation of

$${max}_{s ∈ S} \{ {t}_{{m}_{j} , s} \}$$

over a validation set of examples. Aggregation functions include but are not limited to min, mean, max, and sum. The number of states can be explored from 1 . . . k until a maximum in the likelihood is found (the peak method) or until the likelihood does not significantly increase (the elbow method). These methods are similar to those of finding an appropriate number of mixtures for a Gaussian mixture distribution.

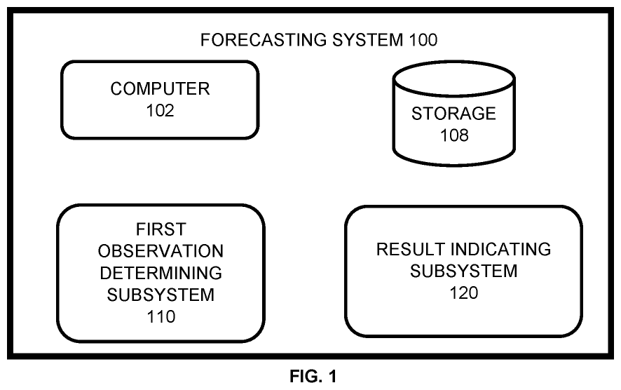

FIG. 1 shows an example forecasting system 100 in accordance with an embodiment of the subject matter. Forecasting system 100 is an example of a system implemented as a computer program on one or more computers in one or more locations (shown collectively as computer 102), with one or more storage devices (shown collectively as storage 108), in which the systems, components, and techniques described below can be implemented.

Forecasting system 100 predicts an observation given one or more previous observations. During operation, forecasting system 100 determines, with first observation determining subsystem 110, a first observation indexed by a first state and a first position, based on the first state, a second observation indexed by a second position and a second state indexed by the first position and the first state, and the second state indexed by the first position and the first state, where the second position is in proximity to the first position, where the second observation was previously determined by dynamic programming, and where the second state was previously determined by dynamic programming.

More specifically, first observation determining subsystem 110 determines o_{i,s}, which corresponds to the first observation based on the first position i and the state s. The second state corresponds to g_{i,s} and a second observation indexed by a second position and a second state corresponds to o_{i-1,g(i,s)}. Moreover, the second position (i−1) is in proximity to the first position (i) because it differs by only one (1). Also, o_{i-1,g(i,s)} was previously determined by dynamic programming as well as g(i, s).

Subsequently, forecasting system 100 returns a result indicating the first observation with result indicating subsystem 120. This step corresponds to returning

$$\hat{μ} ( [ \begin{matrix}h ( s ) \\ {o}_{i - 1 , {g}_{i , s}} \\ h ( {g}_{i , s} )\end{matrix} ] , γ : γ , τ : {τ}^{′} , \dot{μ} , \dot{Σ} ) ,$$

which is a most likely observation based on

$$[ \begin{matrix}h ( s ) \\ {o}_{i - 1 , {g}_{i , s}} \\ h ( {g}_{i , s} )\end{matrix} ] .$$

Note that this function returns the mean of a conditional multivariate Gaussian distribution and the mean is the most likely value (i.e., the probability peaks at the mean). Also note than an observation corresponds to one or more continuous values, which can be in the form of a column vector.

The preceding description is presented to enable any person skilled in the art to make and use the subject matter, and is provided in the context of a particular application and its requirements. Various modifications to the disclosed embodiments will be readily apparent to those skilled in the art, and the general principles defined herein may be applied to other embodiments and appli-cations without departing from the spirit and scope of the subject matter. Thus, the subject matter is not limited to the embodiments shown, but is to be accorded the widest scope consistent with the principles and features disclosed herein.

Embodiments of the subject matter and the functional operations described in this specification can be implemented in digital electronic circuitry, in tangibly embodied computer software or firmware, in computer hardware, including the structures disclosed in this specification and their structural equivalents, or in combinations of one or more of them.

Embodiments of the subject matter described in this specification can be implemented as one or more computer programs, i.e., one or more modules of computer program instructions encoded on a tangible non-transitory program carrier for execution by, or to control the operation of data processing system.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

Alternatively, or in addition, the program instructions can be encoded on an artificially generated propagated signal, e.g., a machine-generated electrical, optical, or electromagnetic signal, that is generated to encode information for transmission to a suitable receiver system for execution by a data processing system. The computer storage medium can be a machine-readable storage device, a machine-readable storage substrate, a random or serial access memory device, or a combination of one or more of them.

Computers suitable for the execution of a computer program include, by way of example, can be based on general or special purpose microprocessors or both, or any other kind of central processing unit. Generally, a central processing unit will receive instructions and data from a read only memory or a random-access memory or both. The essential elements of a computer are a central processing unit for performing or executing instructions and one or more memory devices for storing instructions and data.

A computer can also be distributed across multiple sites and interconnected by a communication network, executing one or more computer programs to perform functions by operating on input data and generating output.

A computer can also be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Generally, a computer will also include, or be operatively coupled to receive data from or transfer data to, or both, one or more mass storage devices for storing data, e.g., magnetic, magneto optical disks, or optical disks. However, a computer need not have such devices.

The term “data processing system’ encompasses all apparatus, devices, and machines for processing data, including by way of example a programmable processor, a computer, or multiple processors or computers.

For a system of one or more computers to be configured to perform particular operations or actions means that the system has installed on it in software, firmware, hardware, or a combination of them that in operation cause the system to perform the operations or actions. For one or more computer programs to be configured to perform particular operations or actions means that the one or more programs include instructions that, when executed by data processing system, cause the system to perform the operations or actions.

The processor and the memory can be supplemented by, or incorporated in, special purpose logic circuitry. More generally, the processes and logic flows can also be performed by and be implemented as special purpose logic circuitry, e.g., an FPGA (field programmable gate array) or an ASIC (application specific integrated circuit), a dedicated or shared processor that executes a particular software module or a piece of code at a particular time, and/or other programmable-logic devices now known or later developed. When the hardware modules or system are activated, they perform the methods and processes included within them.

The system can also include, in addition to hardware, code that creates an execution environment for the computer program in question, e.g., code that constitutes processor firmware, a protocol stack, a database management system, an operating system, or a combination of one or more of them.

The computer-readable storage medium includes, but is not limited to, volatile memory, non-volatile memory, magnetic and optical storage devices such as disk drives, magnetic tape, CDs (compact discs), DVDs (digital versatile discs or digital video discs), computer instruction signals embodied in a transmission medium (with or without a carrier wave upon which the signals are modulated), and other media capable of storing computer-readable media now known or later developed. For example, the transmission medium may include a communications network, such as a LAN, a WAN, or the Internet.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

The methods and processes described in the detailed description section can be embodied as code and/or data, which can be stored in a computer-readable storage medium as described above. When a computer system reads and executes the code and/or data stored on the computer-readable storage medium 120, the computer system performs the methods and processes embodied as data structures and code and stored within the computer-readable storage medium.

The components of the system can be interconnected by any form or medium of digital data communication, e.g., a communication network. Examples of communication networks include a local area network (“LAN”) and a wide area network (“WAN”), e.g., the Internet.

While this specification contains many specific implementation details, these should not be construed as limitations on the scope of any subject matter or of what may be claimed, but rather as descriptions of features that may be specific to particular embodiments of particular subject matters. Certain features that are described in this specification in the context of separate embodiments can also be implemented in combination in a single embodiment.

Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system modules and components in the embodiments described above should not be understood as requiring such separation in all embodiments, and it should be understood that the described program components and systems can generally be integrated together in a single software product or packaged into multiple software products.

The foregoing descriptions of embodiments of the subject matter have been presented only for purposes of illustration and description. They are not intended to be exhaustive or to limit the subject matter to the forms disclosed. Accordingly, many modifications and variations will be apparent to practitioners skilled in the art. Additionally, the above disclosure is not intended to limit the subject matter. The scope of the subject matter is defined by the appended claims.

What is claimed is:

1. A computer-implemented method for facilitating forecasting comprising:
determining a first observation indexed by a first state and a first position, based on the first state, a second observation indexed by a second position and a second state indexed by the first position and the first state, and the second state indexed by the first position and the first state,
wherein the second position is in proximity to the first position,
wherein the second observation was previously determined by dynamic programming, and
wherein the second state was previously determined by dynamic programming; and
returning a result indicating the first observation.

2. The method of claim 1,
wherein determining the first observation is based on a multivariate Gaussian distribution comprising a mean vector and a covariance matrix.

3. The method of claim 2,
wherein the mean vector and covariance matrix are learned from training data comprising at least two observations.

4. The method of claim 3,
wherein the mean vector and the covariance matrix are learned from training data comprising a first one-hot representation of the first state and a second one-hot representation of the second state.

5. One or more non-transitory computer-readable storage media storing instructions that when executed by one or more computers cause the one or more computers to perform operations for facilitating forecasting, comprising:
determining a first observation indexed by a first state and a first position, based on the first state, a second observation indexed by a second position and a second state indexed by the first position and the first state, and the second state indexed by the first position and the first state,
wherein the second position is in proximity to the first position,
wherein the second observation was previously determined by dynamic programming, and
wherein the second state was previously determined by dynamic programming; and
returning a result indicating the first observation.

6. The one or more non-transitory computer-readable storage media of claim 5,
wherein determining the first observation is based on a multivariate Gaussian distribution comprising a mean vector and a covariance matrix.

7. The one or more non-transitory computer-readable storage media of claim 6,
wherein the mean vector and covariance matrix are learned from training data comprising at least two observations.

8. The one or more non-transitory computer-readable storage media of claim 7,
wherein the mean vector and the covariance matrix are learned from training data comprising a first one-hot representation of the first state and a second one-hot representation of the second state.

9. A system comprising one or more computers and one or more storage devices storing instructions that when executed by the one or more computers cause the one or more computers to perform operations for facilitating forecasting, comprising:
determining a first observation indexed by a first state and a first position, based on the first state, a second observation indexed by a second position and a second state indexed by the first position and the first state, and the second state indexed by the first position and the first state,
wherein the second position is in proximity to the first position,
wherein the second observation was previously determined by dynamic programming, and
wherein the second state was previously determined by dynamic programming; and
returning a result indicating the first observation.

10. The system of claim 9,
wherein determining the first observation is based on a multivariate Gaussian distribution comprising a mean vector and a covariance matrix.

11. The system of claim 10,
wherein the mean vector and covariance matrix are learned from training data comprising at least two observations.

12. The system of claim 11,
wherein the mean vector and the covariance matrix are learned from training data comprising a first one-hot representation of the first state and a second one-hot representation of the second state.
